(19) United States
(12) Patent Application Publication
(10) Pub. No.: US 2007/0039930 A1
(43) Pub. Date: Feb. 22, 2007

(54) Method and device for laser welding of elements of sintered material

(76) Inventors: Piergiorgio Romanin, Orbassano (Torino) (IT); Massimo Asti, Orbassano (Torino) (IT); Silvio Corrias, Orbassano (Torino) (IT); Marco Pidria, Orbassano (Torino) (IT)

Correspondence Address: NIXON & VANDERHYE, PC, 901 NORTH GLEBE ROAD, 11TH FLOOR, ARLINGTON, VA, 22203, US

(21) Appl. No.: 10/575,251

(22) PCT Filed: Jun. 29, 2005
(86) PCT No.: PCT/IB05/01946

§ 371 Date: Apr. 10, 2006

(30) Foreign Application Priority Data
Jul. 13, 2004 (EP) 04425519.8

(51) Int. Cl. B23K 26/20; B23K 26/14

(52) U.S. Cl. 219/121.64; 219/121.63; 219/121.84

(57) ABSTRACT

A method is described for laser welding of sintered materials, in which the laser weld is executed with the addition of a weld material, the latter being adducted simultaneously to the welding step in the form of metal dusts, at a junction area between the parts to be joined (1,2).

The present invention relates to methods for laser welding of elements of sintered material.

Heretofore, the techniques and processes developed in this field have not been totally satisfactory from the viewpoint of the quality of the weld obtained. This is due to the fact that the sintered material has differences in density with respect to solid steel. During the welding operation, the molten material tends to shrink in volume, going to fill the residual porosities. During the cooling of the molten area, this phenomenon causes the formation of flaws and cracks the compromise the soundness of the weld. Moreover, the air contained in the porosities contributes to the formation of the aforesaid flaws.

Solutions proposed heretofore in the attempt to solve this problem (see for example the German patent application DE 40 19 098) are not wholly satisfactory and in any case entail complications in the process and in the tool dedicated thereto.

JP-A-08 290292 discloses a method for laser welding of a first element and a second element, in which at least said first element is of sintered material, and in which a laser beam is focused in proximity to the welding area, said method being characterised in that the laser welding operation is conducted with the addition of weld material, in form of a solid insert. This solution does not always prove to be satisfactory.

The object of the present invention is to overcome all the aforesaid drawbacks, assuring in particular the obtainment of laser welds of sintered materials having a high quality.

In view of the achievement of this object, the invention relates to a method for laser welding of a first element and a second element, in which at least said first element is of sintered material, and in which a laser beam is focused in proximity to the welding area, wherein the laser welding operation is conducted with the addition of weld material, characterised in that the weld material is adducted simultaneously to the welding operation and is in form of metal dusts.

Studies and experiences conducted by the applicant have shown that the method of the invention is able, thanks to the aforesaid characteristic, to overcome all the above drawbacks.

It is to be noted that supplying a flow of dusts at a weld area, during a laser welding operation is known from EP-A-O 444 550. However, this prior solution was devised for welding solid metal pieces, while the present invention is based on the novel application of this concepts to the field of welding of sintered pieces.

The dust used as weld material is preferably a mixture of metal dusts, whose composition varies according to the sintered material to be welded.

The grain size of the dusts preferably ranges between 0.010 and 0.100 mm. The dusts are adducted to the weld area by means of an adduction nozzle. Said nozzle can be a separate nozzle from the nozzle normally used for the adduction of the covering gas necessary during the laser welding operation. Alternatively, a single nozzle can be used both for the weld dusts and for the covering gas. The choice depends mainly on the geometry of the junction to be welded.

Also preferably, the angle of adduction of the dusts ranges between 15° and 75° relative to the plane of the junction to be welded. Moreover, for particular types of junctions, particularly shaped laser beams may be used, for example having a rectangular or square section, or with dual focusing focal point (i.e. with dual spot), in order to cover the weld area in optimal fashion.

At the junction between the two elements where welding is performed there is preferably provided a throat with suitable geometry, for receiving the metal dusts.

For particular compositions of sintered materials, it is possible to use laser sources with different wavelengths (CO₂, Nd-YAG, High Power Laser Diode).

Naturally, the invention is also aimed at the device for the execution of the aforesaid method.

The invention shall be further described with reference to the accompanying drawings, provided purely by way of non limiting example, in which:

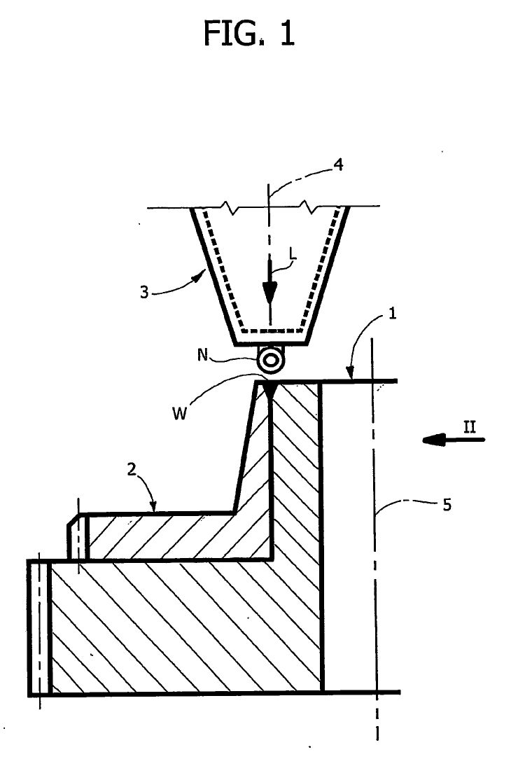

FIG. 1 schematically shows a first possible embodiment of the welding method according to the invention, applied to the weld of a gear for a transmission for a motor vehicle, and

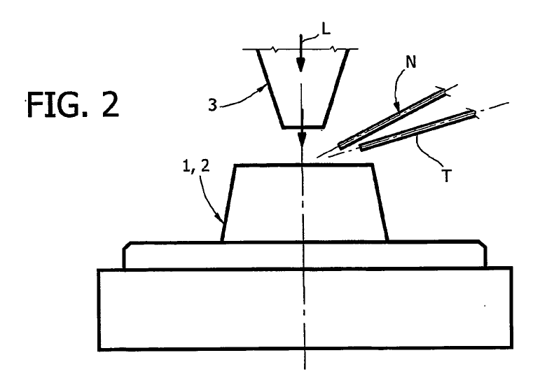

FIG. 2 is a view of the device of FIG. 1 according to the arrow II of FIG. 1.

The examples shown in the accompanying figures refer to the case of a gear 1 of sintered material (shown only partially in FIG. 1), to be used in a transmission of a motor vehicle. On the gear 1 is mounted with interference and subsequently laser welded a synchroniser ring 2, for example made of massive or solid steel. The reference number 3 designates the terminal portion of a focusing head of a laser beam L In the illustrated example, the head is oriented according to a vertical axis 4 parallel to the axis 5 of the gear 1. During the welding process, the gear 1 is set in rotation around its axis (by means of equipment of any known type) in such a way as cause a relative motion of the laser beam L relative to the piece which brings about the execution of an annular weld bead W along the coupling surface between gear 1 and synchroniser ring 2, at one end of the gear.

In the case of the embodiment of FIGS. 1 and 2, adjacent to the laser focusing head is provided a nozzle N for the adduction of the covering gas normally used during laser weld processes.

According to this embodiment of the invention, the nozzle N is also used for the adduction of weld material in the form of metal dusts. If necessary, a second nozzle T, separate from the nozzle N, (FIG. 2) can be provided for the adduction of the dusts. In this case, the nozzle N is used solely for supplying the covering gas.

As indicated above, the dusts used is a mixture of metal dusts whose compositions varies according to the sintered material to be welded and on the mechanical performance required by the weld.

The grain size of the dusts preferably ranges between 0.010 and 0.100 mm.

Also as stated above, the nozzle used for the adduction of the dusts is preferably inclined by an angle ranging between 15° and 75° relative to the plane of the junction (the horizontal plane with reference to the drawing).

As indicated above, the composition of the weld material provided according to the invention changes according to the applications, and mainly as a function of the sintered material to be welded and on the mechanical performance required by the weld.

Independently of the embodiment, the relative position of the axis of the laser beam L relative to the axis of the junction is selected according to the materials to be welded, and in this regard in some cases it may be convenient to focus the laser beam L more on one of the two parts to be welded; for example, with reference to the exemplified case, a third of the diameter of the laser spot could be focused on the gear 1 made of sintered material and two thirds on the solid steel ring 2.

Moreover, as indicated above, the laser beam can be shaped in a particular manner, for example with a non circular section, such as a rectangular or square section, or with a dual-focus optical system with variation of the distance between the spot lasers produced, if this is preferable to cover the weld area in Optimal fashion.

Lastly, the method provides for the use of Laser sources of any kind, including CO₂, Nd-YAG, High Power Laser Diode sources.

Naturally, without altering the principle of the invention, the construction details and the embodiments may vary widely from what is described and illustrated purely by way of example herein, without thereby departing from the scope of the present invention.

1. A method for laser welding of a first element (1) and a second element (2), in which at least said first element is of sintered material, comprising the step of focusing a laser beam (L) in proximity to the welding area (W, 6), wherein the laser welding operation is conducted with the addition of a weld material (7), characterised in that the weld material is adducted simultaneously to the welding operation and is in form of metal dusts.

2. Method as claimed in claim 1, characterised in that the dust used is a mixture of metal dusts.

3. Method as claimed in claim 1, characterised in that the grain size of the dusts ranges between 0.010 and 0.100 mm.

4. Method as claimed in claim 1, characterised in that a nozzle for the adduction of the dusts (T) is provided, separate from a nozzle (N) for the adduction of covering gas.

5. Method as claimed in claim 1, characterised in that the dusts are adducted by means of the nozzle (N) used for supplying covering gas.

6. Method as claimed in claim 1, characterised in that the angle of adduction of the dusts ranges between 15° and 75° relative to the plane of the weld area (W).

7. Method as claimed in claim 1, characterised in that the laser weld is conducted at a junction area between the first and the second element (1, 2) and that at the aforesaid junction area is provided a seat or throat for receiving the dust material.

8. Method as claimed in claim 7, characterised in that the seat or throat is formed in part in the first element (1) and in part in the second element (2) to be welded.

9. Method as claimed in claim 1, characterised in that the relative position of the axis of the laser beam (L) relative to the plane of the weld area (W) is chosen according to the materials constituting said first and second element (1, 2).

10. Method as claimed in claim 1, characterised in that the laser beam (L) is focused to a greater extent on one of said first and second element (1, 2) than on the other.

11. Method as claimed in claim 1, characterised in that the laser beam is shaped with a non circular section, such as a square or rectangular section.

12. Method as claimed in claim 1, characterised in that the laser beam is shaped by means of a dual-focus optical system with variation of the distance between the laser spots produced.

13. Method as claimed in claim 1, characterised in that a laser source chosen among CO2, Nd-YAG, High Power Laser Diode is used.

14. Device for laser welding of a first element (1) and a second element (2), in which at least said first element is of sintered material, comprising:
means for supporting the two elements to be welded,
a focusing head for focusing a laser beam (L) in the weld area (W)
means for imparting a relative motion between the focusing head (3) and the elements (1, 2) to be welded, in order to form a weld bead, and
means for supplying a flow of metal dusts to the weld area (W, 6) during the execution of the weld.

15. Device as claimed in claim 14, characterised in that said means include a nozzle (N, T) for supplying the dusts arranged in proximity to the weld area in a fixed position relative to the focusing head.

16. Device as claimed in claim 15, characterised in that said nozzle (T) is a separate nozzle relative to a nozzle (N) used for supplying covering gas.

17. Device as claimed in claim 15, characterised in that said nozzle is also used for supplying covering gas.
